(19) United States
(12) Patent Application Publication
(10) Pub. No.: US 2025/0003799 A1
(43) Pub. Date: Jan. 2, 2025

(54) Optical Radiation Measurement Method and Device

(71) Applicant: HANGZHOU EVERFINE PHOTO-E-INFO CO., LTD., Hangzhou (CN)

(72) Inventors: Jiangen PAN, Hangzhou (CN); Li SONG, Hangzhou (CN); Qian LI, Hangzhou (CN)

(73) Assignee: HANGZHOU EVERFINE PHOTO-E-INFO CO., LTD., Hangzhou (CN)

(21) Appl. No.: 18/648,774

(22) Filed: Apr. 29, 2024

(30) Foreign Application Priority Data
Jun. 27, 2023 (CN) 202310766076.4
Jun. 27, 2023 (CN) 202321646343.6

(51) Int. Cl. G01J 3/28; G01J 3/02; G06T 7/90

(52) U.S. Cl. CPC G01J 3/2823; G01J 3/0208; G01J 3/0291; G06T 7/90; G01J 2003/2826; G06T 2207/10024; G06T 2207/10036

(57) ABSTRACT

Present invention provides an imaging optical radiation measurement device, including a chassis, which is equipped with an optical lens. The chassis includes a first array detector, a spectral measurement module, a color filter wheel set, a light path switching device, and a signal processing and output unit. The color filter wheel set has a plurality of apertures, and two or more pieces of color filters are set in the apertures; the measured light beam passes through the optical lens and enters the chassis, and a light path switching Device will be measured beam at the same time or successively switched to two or more measurements in the optical path. The present invention also provides a display light field radiation measurement method to realize the measurement of hyperspectral information of the display to be measured.

### TECHNICAL FIELD

The present invention relates to the field of photo-electric measurement, in particular to a display optical field radiation measuring method and an imaging optical radiation measuring device.

### BACKGROUND

Nowadays, with the flourishing development of display technologies, rapid and accurate measurement on basic optical parameters such as luminance and chromaticity is crucial for the research and development, production, and quality control of display screens. The luminance and chromaticity of a display screen are generally measured with a point type spectroradiometer, an imaging colorimeter, a point-of-aim luminance meter, or an image type luminance meter.

The point type spectroradiometer can measure the luminance and chromaticity only in a single small region, and requires a lot of time to evaluate the uniformity of display. The imaging luminance and colorimeter can quickly obtain photometric and colorimetric information of all light-emitting positions on the display screen by means of imaging. The imaging luminance & colorimeter has a two-dimensional planar array detector and a filter group matching a human visual function in front of the two-dimensional planar array detector, and can quickly obtain the luminance of each point in the two-dimensional plane of the display screen through a single imaging measurement. However, the filter group is difficult in fully matching human visual perception, resulting in large measurement errors. Although the spectral power distribution of a small region can be measured by the point type spectroradiometer to correct the imaging luminance and chromaticity, spectra measured by the spectroradiometer in this method cannot correspond to each pixel in the image, and the luminous of the display screen are often uneven, so the correction coefficient of the small region cannot be applied to the luminance and chromaticity correction of the entire region of the display screen. In addition, the spectral power distribution of the display screen varies greatly under different gray scales, so that the imaging luminance and colorimeter cannot accurately measure full gray scale images through one calibration.

In recent years, hyperspectral imaging colorimeters have emerged in the market for display photometric and colorimetric measurement. The colorimeters use a lot of narrow band filters to obtain hyperspectral images, so as to calculate the luminance and chromaticity of each point on the display screen. However, the excessive narrow band filters lead to a low measurement speed, and cannot meet the requirements for rapid measurement in the research and development, production, and quality control processes of display screens.

### SUMMARY

In response to the shortcomings of the prior art, the present invention provides a display optical field radiation measuring method and an imaging optical radiation measuring apparatus to quickly and accurately measure the luminance, chromaticity, and uniformity of a display screen.

To achieve the above objectives, the present invention provides a display optical field radiation measuring method, which measures hyperspectral information of a to-be-measured display screen by a spectral measurement module, filters, and an imaging measuring apparatus including a planar array detector. The method includes the following steps:
S1: controlling the to-be-measured display screen to display a first group of pictures, and obtaining spectral power distributions in an A region of the to-be-measured display screen in the corresponding pictures by using the spectral measurement module;
S2: selecting two or more specific filters according to the spectral power distributions in the A region obtained in step S1;
S3: controlling the to-be-measured display screen to display a second group of pictures, and cutting the filters selected in step S2 into a light path sequentially, where light in a B region of the to-be-measured display screen is received by the planar array detector through an imaging lens and the filters, and positions in the B region of the to-be-measured display screen correspond to specific pixels of the planar array detector; and
S4: calculating, according to pixel response values of the planar array detector in step S3 and the spectral power distributions in the A region of the to-be-measured display screen in step S1, a spectral power distribution at each position in the B region when the to-be-measured display screen displays the second group of pictures.

It should be noted that, in the technical solution, the B region may be an entire light emitting region of the to-be-measured display screen, and the A region may be a designated light emitting region on the to-be-measured display screen, and the A region is located within the B region, as shown in FIG. 1. A pixel or a set of more pixels specific on the planar array detector corresponds to the A region. The hyperspectral information of the to-be-measured display screen refers to spectral power distribution data of each position in the B region. The first group of pictures and the second group of pictures may be either a picture or a group of two or more pictures, respectively. The filters selected in step S2 are generally bandpass filters.

In the foregoing technical solution, after the spectral power distributions in the A region of the to-be-measured display screen in the corresponding pictures are obtained by using the spectral measurement apparatus, primary color peak wavelengths of the to-be-measured display screen are obtained according to the spectral power distributions in the A region, where transmission bands of the selected two or more bandpass filters cover the primary color peak wavelengths of the to-be-measured display screen measured in step S1.

Further, each primary color of the to-be-measured display screen corresponds to at least one bandpass filter, and the quantity of the bandpass filters is greater than or equal to that of primary colors of the to-be-measured display screen. Generally, the more the bandpass filters, the higher the measurement accuracy, but the longer the measurement time. In this technical solution, the quantity of the bandpass filters can be reasonably determined according to actual needs.

In the foregoing technical solution, in step S1, the to-be-measured display screen is controlled to display the first group of pictures, where the first group of pictures includes two or more different pictures, and the spectral measurement module measures a spectral power distribution in each picture.

In the foregoing technical solution, step S4 specifically includes: analyzing a spectral power distribution curve and a spectral peak position of each primary color of the to-be-measured display screen according to the spectral power distributions (S_{R}(λ), S_{G}(λ), and S_{g}(λ)) in the A region measured by the spectral measurement module in step S1 when the to-be-measured display screen displays the first group of pictures; measuring, according to step S3 and by using the imaging apparatus, photometric and colorimetric signals in the B region when the to-be-measured display screen displays the second group of pictures, selecting a specific combination of bandpass filters according to the spectral peak position of each primary color of the to-be-measured display screen, obtaining the pixel response values under different bandpass filters by the planar array detector, and then calculating primary color peak intensity coefficients (k_{R}_{_{i,j}}, k_{G}_{_{i,j}}, and k_{B}_{_{i,j}}) at each position in the B region when the to-be-measured display screen displays the second group of pictures; and superposing the spectral power distributions of primary colors in the A region of the to-be-measured display screen according to the primary color peak intensity coefficients at a position (i,j) in the B region of the to-be-measured display screen, and calculating a spectral power distribution S(λ)_{i,j} at the position (i,j) in the B region of the to-be-measured display screen according to formula (1). After the spectral power distribution at each position in the B region is obtained, luminance and chromaticity coordinates of each position in the B region are obtained by calculation, as shown in FIG. 2.

$${S ( λ )}_{i , j} = {k}_{{R}_{i , j}} {S}_{R} ( λ ) + {k}_{{G}_{i , j}} {S}_{G} ( λ ) + {k}_{{B}_{i , j}} {S}_{B} ( λ ) \qquad ( 1 )$$

Where S_{R}(λ) is a spectral power distribution of the red primary color; S_{G}(λ) is a spectral power distribution of the green primary color; S_{B}(λ) is a spectral power distribution of the blue primary color; and k_{R}_{_{i,j}}, k_{G}_{_{i,j}}, and k_{B}_{_{i,j}} are the primary color peak intensity coefficients.

It should be noted that the primary color peak intensity coefficients k_{R}_{_{i,j}}, k_{G}_{_{i,j}}, and k_{B}_{_{i,j}} generally refers to absolute value coefficients.

Further, in the foregoing technical solution, the first group of pictures in step S1 and the second group of pictures in step S3 have one or more identical pictures, response values obtained by the planar array detector in the A region under different bandpass filters in the same picture are compared with absolute peak intensities of the spectral power distributions in the A region obtained in step S1 to obtain the primary color peak intensity coefficient responsivities under the combination of the planar array detector and the bandpass filters, and then primary color peak intensity coefficients at each position in the corresponding picture are obtained when any picture on the to-be-measured display screen is measured.

Specifically, in the foregoing technical solution, in step S2, the selected bandpass filters (filter₁, filter₂ . . . filterₙ) are cut into the light path sequentially to obtain the pixel response values (D₁, D₂ . . . Dₙ) obtained by the planar array detector in the A region under the selected bandpass filters when the to-be-measured display screen displays a specific picture, which are compared with peak intensities (P₁(λ₁), P₂(λ₂) . . . Pₙ(λₙ)) corresponding to the bandpass filters in the spectral power distributions in the A region obtained in step S, where λ₁, λ₂ . . . λₙ are corresponding peak wavelengths; and peak intensity coefficient responsivities (R₁, R₂, . . . , Rₙ) of each pixel response of the planar array detector under the bandpass filterₙ according to formula (2). The pixel response values obtained by the planar array detector in step S3 are corrected through the peak intensity coefficients, so as to obtain the primary color peak intensity coefficients at each position in the corresponding picture.

$${r}_{m} = \frac{{P}_{m} ( {λ}_{m} )}{{D}_{m}} \qquad ( 2 )$$

Where Dₘ is a pixel response, obtained by the planar array detector, of the A region under the bandpass filterₙ; Pₘ(λₘ) is a peak intensity corresponding to the m^{th} bandpass filter in the spectral power distributions in the A region obtained in step S1; and rₘ is a peak intensity coefficient responsivity of each pixel response of the planar array detector under the bandpass filter. The color peak intensity coefficient at the position of any picture on the to-be-measured display screen is obtained as the product of the corresponding pixel response and the peak intensity coefficient responsivity.

It should be noted that the spectral responsivity of the spectral measurement module and the responsivity of pixels of the planar array detector under different bandpass filters can be calibrated in advance through a standard light source with known spectral power distribution. The standard light source is generally a continuous spectrum light source with a standard magnitude, including but not limited to standard A light source, D65 energy spectrum light source, or the like. According to the previous calibration, the primary color peak intensity coefficients at each position can be directly analyzed from the pixel response values obtained by the planar array detector under different bandpass filters.

In the foregoing technical solution, the first group of pictures in step S1 includes two or more pictures in different gray scales; and primary color spectral power distributions of the display screen under the first group of picture in different gray scales are analyzed in step S4, a gray scale of each position is determined according to the pixel response values when the second group of pictures is analyzed, and the primary color spectral power distribution in the corresponding gray scale is combined with the primary color peak intensity coefficient to obtain the spectral power distribution at each position. The spectral power distributions are measured in a plurality of gray scales because the spectral power distributions of some display screens change with different gray scales. This solution fully considers this problem and determines a gray-scale region based on the response value, thereby combining the more suitable identical spectral power distribution with the primary color peak intensity coefficient to obtain more accurate hyperspectral information.

Specifically, a corresponding relationship between each primary color peak intensity coefficient and gray scale at each position in the B region when the to-be-measured display screen displays pictures of different gray scales is obtained through the first group of pictures, and a database is established. When the second group of pictures is measured, a primary color spectral power distribution in a corresponding gray scale is searched through the primary color peak intensity coefficients, and the spectral power distribution at each position in the current gray scale is further obtained.

It should be noted that an ordinary display screen is composed of red, blue, and green sub-pixels, output of each color of sub-pixels may be divided into 256 gray scales, and gray scales of a displayed picture are generally expressed as (gray scales R, gray scales G, and gray scales B). The primary color picture is a 255 gray-scale pure color image displayed by single sub-pixels, namely, a pure red (255, 0, 0), pure green (0, 255, 0), or pure blue (0, 0, 255) picture. The picture mixed with a plurality of primary colors is a mixed color picture displayed by red, blue, and green primary color sub-pictures according to different gray scale ratios. When the display screen displays a gray scale of 255 in red, blue, and green, the picture displayed by the display screen is a pure white picture (255, 255, 255). A person skilled in the art should understand that there may be other primary colors on the display screen besides red, blue, and green, and the above description can be referred to.

As a technical solution, in order to obtain more accurate luminance and chromaticity coordinates at each position in the B region, a filter or combination of filters simulating the luminance or chromaticity response of human eye may be introduced to further correct the luminance and chromaticity coordinates at each position in the B region. Specifically, after step S4, the following steps are further included:
S5: cutting a filter (a group of tristimulus value filters) simulating the luminance or chromaticity response of human eye into the measuring light path, as shown in FIG. 9, and controlling the to-be-measured display screen to display a third group of to-be-measured pictures, where the beam emitted by the display screen enters the planar array detector through the filter, so as to obtain luminance values or tristimulus values at each position in the B region of the to-be-measured display screen;
S6: obtaining luminance or tristimulus value correction coefficients for each position in the B region by using a correction algorithm according to the spectral power distribution obtained in step S4; and
S7: correcting the luminance values or tristimulus values obtained in step S5 by using the correction coefficients obtained in step S6 to obtain corrected luminance values or tristimulus values at each position in the B region in the third group of pictures.

Preferably, the third group of pictures in step S5 is the same as the second group of pictures.

In the foregoing technical solution, the correction algorithm described in step S6 includes, but is not limited to, a spectral mismatch correction algorithm and a ratio method.

In a specific implementation solution, the tristimulus value correction coefficients F*(S_{Z}(λ))_{i,j} for the position (i, j) in the B region of the to-be-measured display screen are calculated by the spectral mismatch correction algorithm, and the tristimulus value correction coefficients F*(S_{Z}(λ))_{i,j} for the position (i, j) in the B region are calculated according to formula (3).

$$F * {( {S}_{Z} ( λ ) )}_{i , j} = \frac{{S}_{A}}{{S}_{Z}} = \frac{{\int }_{{λ}_{min}}^{{λ}_{max}} {S}_{A} ( λ ) \cdot {s}_{rel} ( λ ) d λ}{\int \text{?} {S}_{A} ( λ ) \cdot V ( λ ) d λ} / \frac{{\int }_{{λ}_{min}}^{{λ}_{max}} {S}_{Z} ( λ ) \cdot {s}_{rel} ( λ ) d λ}{\int \text{?} {S}_{Z} ( λ ) \cdot V ( λ ) d λ} \qquad ( 3 )$$

$$\text{?} \text{indicates text missing or illegible when filed}$$

Where S_{A}(λ) represents a relative spectral power distribution of the standard light source; sᵣₑₗ(λ) represents actual spectral responsivity curves (xᵣₑₗ(λ), yᵣₑₗ(λ), and zᵣₑₗ(λ)) of the planar array detector with the filter simulating the chromaticity response of human eye; S_{Z}(λ) represents a relative spectral power distribution of the to-be-measured display screen; and V(λ) represents three standard colorimetric observer functions, and can be replaced CIE tristimulus curves x(λ), y(λ), and z(λ). Three corresponding stimulus correction coefficients F*(S_{Z}(λ)) are obtained accordingly, denoted as k(x)_{i,j}, k(y)_{i,j} and k(z)_{i,j}, respectively.

In another specific implementation solutions, the tristimulus value correction coefficients F*(S_{Z}(λ)) for the position (i, j) in the B region of the to-be-measured display screen are calculated by a ratio method, and there are also three corresponding stimulus correction coefficients, denoted as k(x)_{i,j}, k(y)_{i,j}, and k(z)_{i,j} and calculated according to formula (4).

$${k ( x )}_{i , j} = {X}_{{N}_{i , j}} / {X}_{{M}_{i , j}} , {k ( y )}_{i , j} = {Y}_{{N}_{i , j}} / {Y}_{{M}_{i , j}} , {k ( z )}_{i , j} = {Z}_{{N}_{i , j}} / {Z}_{{M}_{i , j}} \qquad ( 4 )$$

Where X_{N}_{_{i,j}}, Y_{N}_{_{i,j}}, and Z_{N}_{_{i,j}} are tristimulus values calculated from the spectral power distribution at each position (i,j) obtained in step S4; and X_{M}_{_{i,j}}, Y_{M}_{_{i,j}}, and Z_{M}_{_{i,j}} are tristimulus values at each position (i,j) obtained in step S5.

Further, the second group of pictures in step S3 is primary colors respectively and the mixture of primary colors, all have the same gray scale, and the spectral power distribution at each position in these pictures is obtained in step S4; in step S5, the filters simulating the chromaticity response of human eye are sequentially cut in; the correction algorithm used in step S6 is a matrix correction algorithm, and the tristimulus value correction coefficients at all positions are of a correction coefficient matrix; and the third group of pictures in steps S5 and S7 are any display pictures.

It should be noted that the tristimulus value correction matrix at the position (i,j) in the B region may be obtained by a matrix correction algorithm. Specifically, taking the red, blue, and green primary color display screen as an example, the specific set of pictures includes three primary color pictures (pure red (255, 0, 0), pure green (0, 255, 0), and pure blue (0, 0, 255)). Tristimulus values N_{RGB}_{_{i,j}} of three primary colors can be calculated according to the spectral power distribution in the B region of each picture obtained in step S4, tristimulus values M_{RGB}_{_{i,j}} of three primary colors of each picture can be obtained according to step S5, and a tristimulus value correction matrix R_{i,j} is calculated by formula (5).

Where

$${R}_{i , j} = {N}_{{RGB}_{i , j}} \cdot {M}_{{RGB}_{i , j}}^{- 1} \qquad ( 5 )$$

$${N}_{RGB} = \vert \begin{matrix}{X}_{NR} & {X}_{NG} & {X}_{NB} \\ {Y}_{NR} & {Y}_{NG} & {Y}_{NB} \\ {Z}_{NR} & {Z}_{NG} & {Z}_{NB}\end{matrix} \vert , and {M}_{RGB} = \vert \begin{matrix}{X}_{MR} & {X}_{MG} & {X}_{MB} \\ {Y}_{MR} & {Y}_{MG} & {Y}_{MB} \\ {Z}_{MR} & {Z}_{MG} & {Z}_{MB}\end{matrix} \vert .$$

After the tristimulus value correction matrix R is calculated, the filters simulating the chromaticity response of human eye are sequentially cut into the light path to obtain tristimulus values M_{i,j}, as shown in formula (6). Combined with the correction matrix R_{i,j}, corrected tristimulus values M′_{i,j} are calculated by formula (7).

$${M}_{i , j} = \vert \begin{matrix}{X}_{{M}_{i , j}} \\ {Y}_{{M}_{i , j}} \\ {Z}_{{M}_{i , j}}\end{matrix} \vert \qquad ( 6 )$$

$${M}_{i , j}^{′} = {R}_{i , j} \cdot {M}_{i , j} = \vert \begin{matrix}{X}_{{M}_{i , j}}^{′} \\ {Y}_{{M}_{i , j}}^{′} \\ {Z}_{{M}_{i , j}}^{′}\end{matrix} \vert \qquad ( 7 )$$

Where X_{M}_{_{i,j}}, Y_{M}_{_{i,j}}, and Z_{M}_{_{i,j}} are measured tristimulus values before correction; and X_{M}_{_{i,j}}′, Y_{M}_{_{i,j}}′, and Z_{M}_{_{i,j}}′ are corrected tristimulus values.

Further, in order to improve measurement efficiency and reduce measurement steps, rapid measurement is implemented by presetting a correction coefficient database. Specifically, different types of calibrated display screens are used as calibration objects to control display of different gray-scale pictures on the calibrated display screens, and steps S1-S7 are repeated to obtain corresponding relationships between tristimulus value correction coefficients of the calibrated display screens under different gray-scale pictures and tristimulus values obtained from filter channels simulating the chromaticity response of human eye. When the to-be-measured display screen is measured, the tristimulus value correction coefficients in the database are directly called through the tristimulus values obtained from the filter channels simulating the chromaticity response of human eye, so as to obtain corrected tristimulus values of the to-be-measured pictures on the to-be-measured display screen.

Beneficial effects of the present invention are as follows: The present invention provides a display optical field radiation measuring method, which can implement hyperspectral measurement by selecting a few narrow band filters according to the to-be-measured display screen, and combine the filters simulating the chromaticity response of human eye to quickly and accurately measure the luminance and chromaticity at various points in different gray-scale pictures of the to-be-measured display screen. The implementation steps of measurement schemes are simple and practicable, thereby greatly improving measurement efficiency and reducing measurement costs.

In order to achieve the objectives, the present invention further employs the following technical solution:

The present invention provides an imaging optical radiation measuring apparatus, including a housing, where an optical lens is disposed on the housing; a first array detector, a spectral measurement module, a filter wheel set, a light path switching apparatus, and a signal processing and output unit are disposed in the housing; the filter wheel set has a plurality of hole positions, and two or more filters are disposed in the hole positions; a measured beam enters the housing through an optical lens, and the light path switching apparatus switches the measured beam to two or more measuring light paths simultaneously or sequentially, where a first measuring light path is from the optical lens to the first array detector to obtain a spectral image of a to-be-measured display screen and then calculate luminance and chromaticity of the image at each point, and a second measuring light path is from the optical lens to the spectral measurement module to obtain a spectral power distribution at a specific point; the filter wheel set is disposed between the optical lens and the first array detector; and the signal processing and output unit is electrically connected to the first array detector and the spectral measurement module respectively, and the signal processing and output unit receives measurement signals from the first array detector and the spectral measurement module, and corrects measurement results of the first array detector by using measurement results of the spectral measurement module, so as to quickly and accurately measure the luminance, chromaticity, and uniformity of the to-be-measured display screen. The first array detector is generally a planar array detector.

As a technical solution, the light path switching apparatus is a light splitter, the measured beam coming from the optical lens and incident to the light splitter is split into two or more paths of outgoing beams, one path of outgoing beam is incident to the first array detector to form the first measuring light path, and the other path of outgoing beam is incident to the spectral measurement module to form the second measuring light path. The light splitter is generally a semi-transparent and semi-reflective mirror.

In a specific implementation, an optical lens is disposed on the housing; a first array detector, a spectral measurement module, a filter wheel set, a light splitter, and a signal processing and output unit are disposed in the housing; and the light splitter is disposed on a light path between the optical lens and the filter wheel set. A measured beam enters the housing through the optical lens, the light splitter splits the measured beam into two or more paths of outgoing beams, one path of outgoing beam is incident to the first array detector through hole positions on the filter wheel set to form the first measuring light path, and the other path of outgoing beam is incident to the spectral measurement module to form the second measuring light path.

In another specific implementation, an optical lens is disposed on the housing; a first array detector, a spectral measurement module, a filter wheel set, a light splitter, and a signal processing and output unit are disposed in the housing; the light splitter is disposed on a hole position of the filter wheel set, and can be cut into or out of the light path behind the optical lens with the rotation of the filter wheel set; the second measuring light path from the optical lens through the light splitter to the spectral measurement module is formed only when the light splitter is cut into the light path; and when the light splitter is cut out of the light path and the filters of the filter wheel set are cut into the light path, the first measuring light path is formed from the optical lens through the hole positions on the filter wheel set to the first array detector.

In another specific implementation, the spectral measurement module includes an incident slit, a dispersion element, and a second array detector. The beam of the to-be-measured display screen enters the housing through the optical lens and is split by the light splitter, then one outgoing beam is incident to the first array detector through the hole positions on the filter wheel set and received by the first array detector to obtain an image in a light transmission band of the filters or a combination of the filters, the other outgoing beam is received by the second array detector through the incident slit and the dispersion element to obtain a spectral power distribution of the to-be-measured display screen, and then luminance and chromaticity data of each point on the to-be-measured display screen are obtained by analysis.

As a technical solution, the light path switching apparatus is a reflector that can be cut into or out of a measuring light path; when the reflector is cut into the light path, the second measuring light path becomes effective; and when the reflector is cut out of the light path, the first measuring light path becomes effective.

In a specific implementation, an optical lens is disposed on the housing; a first array detector, a spectral measurement module, a filter wheel set, a reflector, and a signal processing and output unit are disposed in the housing; the reflector is disposed on a hole position of the filter wheel set, and can be cut into or out of the light path behind the optical lens with the rotation of the filter wheel set; the second measuring light path from the optical lens through the reflector to the spectral measurement module is formed only when the reflector is cut into the light path; and when the reflector is cut out of the light path and the filters of the filter wheel set are cut into the light path, the first measuring light path is formed from the optical lens through the hole positions on the filter wheel set to the first array detector.

Further, receiving surfaces of the first array detector and the spectral measurement module are located on an imaging surface of the optical lens.

As a technical solution, a field diaphragm is further included, and the field diaphragm is disposed in the second measuring light path in front of the spectral measurement module. The field diaphragm is used for adjusting an imaging size to adapt to different receiving ranges of the spectral measurement module, or controlling a field size measured by the spectral measurement module.

Further, a first lens unit is further provided in the second measuring light path between the light path switching apparatus and the field diaphragm. The first lens unit is a single lens. The first lens unit is a field mirror. In the same optical system, adding the field mirror can reduce the area of a light receiving unit of the spectral measurement module. If the light receiving unit of the same area is used, the field mirror can expand its field to increase incident flux.

Further, a second lens unit is further provided in the second measuring light path between the field diaphragm and the spectral measurement module. The second lens unit includes one or of more lenses. The second lens unit is not limited to a single lens or a lens group here, and can be adjusted according to needs. The second lens unit is used for coupling the light passing through the field diaphragm to the receiving surface of the spectral measurement module.

As a technical solution, the filter wheel set is provided with three or more filters simulating the tristimulus value response of human eye, or the filter wheel set is provided with three or more bandpass filters, or the filter wheel set is provided with neutral filters with different transmittance.

As a technical solution, a coaxial driving apparatus is further included, and the coaxial driving apparatus drives the filter wheel set to cut specific filters into a measuring light path sequentially.

Further, the filter wheel set includes two or more color discs; and the coaxial driving apparatus is a timing motor capable of switching and combining two or more color discs in time series, and the timing motor is electrically connected to the two or more color discs in time series to cut the filters on the corresponding color discs into the measuring light path respectively.

As a technical solution, a measurement point of the spectral measurement module is located at a designated position within a measurement region of the first array detector, so as to measure a spectral power distribution at the designated position.

Beneficial effects of the present invention are as follows: The present invention provides an imaging optical radiation measuring apparatus, which can implement hyperspectral measurement by selecting a few narrow band filters according to the measured display screen, and quickly and accurately measure the luminance and chromaticity at various points in different gray-scale pictures of the display screen. The implementation steps of measurement schemes are simple and practicable, thereby greatly improving measurement efficiency and reducing measurement costs.

### BRIEF DESCRIPTION OF THE DRAWINGS

FIG. 1 is a schematic diagram of an A region and a B region of a to-be-measured display screen;

FIG. 2 is a schematic diagram of a display optical field radiation measuring method of the present invention;

FIG. 3 is a flowchart of a display optical field radiation measuring method provided by the first method embodiment of the present invention;

FIG. 4 is a flowchart of a display optical field radiation measuring method provided by the second method embodiment of the present invention;

FIG. 5 is a flowchart of a display optical field radiation measuring method provided by a third method embodiment of the present invention; and

FIG. 6 is a flowchart of a display optical field radiation measuring method provided by a fourth method embodiment of the present invention.

FIG. 7 is a schematic structural diagram of an imaging optical radiation measuring apparatus provided by an embodiment of the present invention;

FIG. 8 is a schematic structural diagram of a spectral measurement module in an embodiment of the present invention;

FIG. 9 is a schematic structural diagram of another imaging optical radiation measuring apparatus provided by an embodiment of the present invention;

FIG. 10 is a schematic structural diagram of still another imaging optical radiation measuring apparatus provided by an embodiment of the present invention;

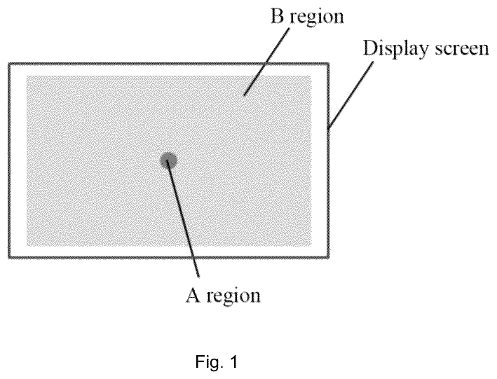

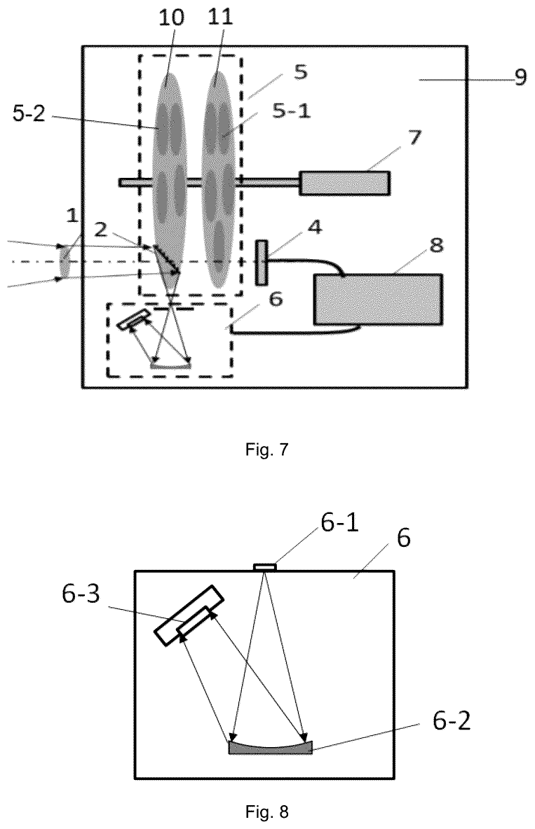

In FIG. 7 to FIG. 10, 1—optical lens, 2—reflector, 3—light splitter, 4—planar array detector, 5—filter wheel, 5-1—bandpass filter, 5-2—filter simulating the chromaticity response of human eye, 6—spectral measurement module, 6-1—incident slit, 6-2—dispersion element, 6-3—second array detector, 7—coaxial driving apparatus, 8—signal processing and output unit, 9—housing, 10—first color disk, and 11—second color disc.

### DETAILED DESCRIPTION OF THE EMBODIMENTS

### First Method Embodiment

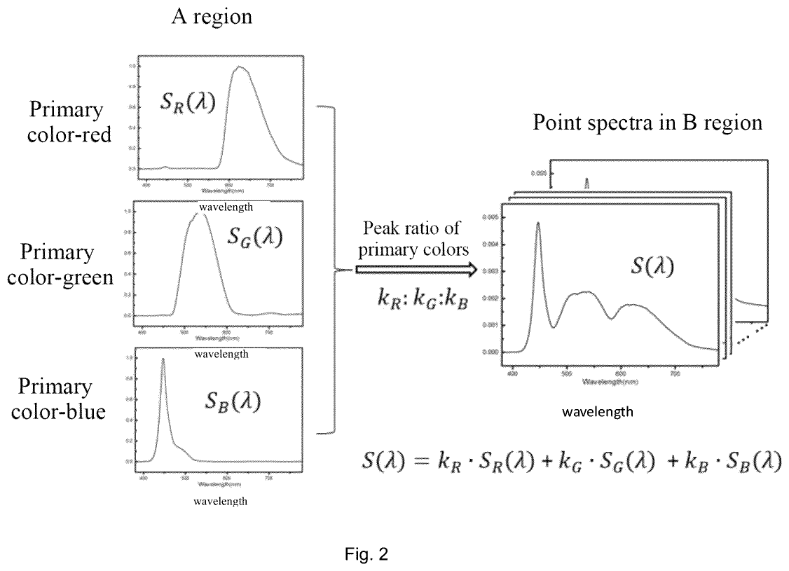

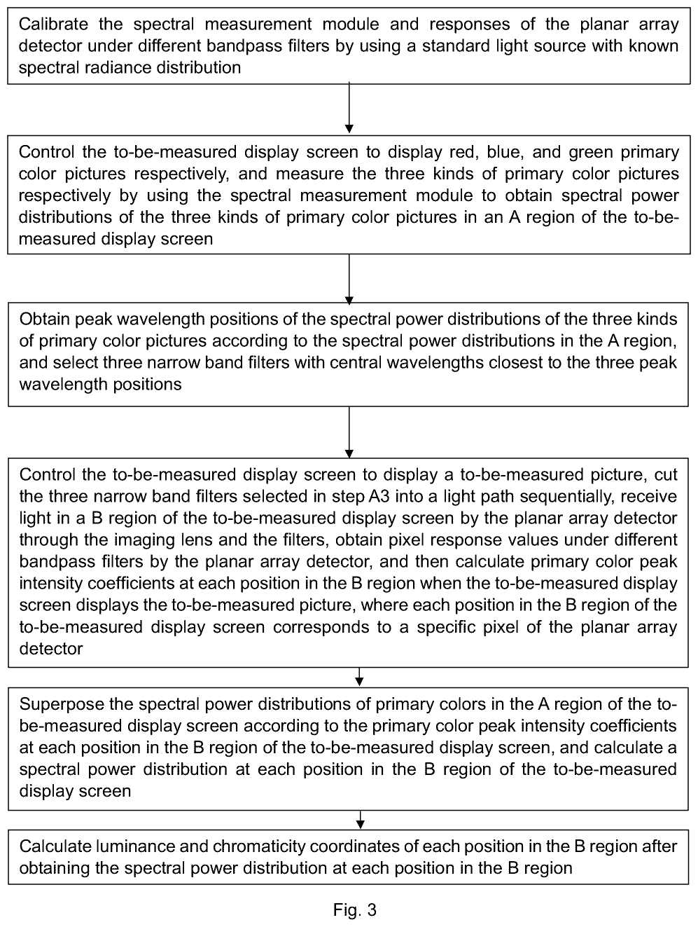

The method embodiment discloses a display optical field radiation measuring method, as shown in FIG. 3. This method using the above described third apparatus embodiment. Response values of the planar array detector under different bandpass filters and the spectral measurement apparatus are calibrated with a standard A light source in advance, and then hyperspectral information of the to-be-measured display screen is measured by using the spectral measurement apparatus, the filters, and an imaging measuring apparatus including the planar array detector. Specifically, the method includes:
A1: Calibrate the spectral measurement module and responses of the planar array detector under different bandpass filters by using a standard light source with known spectral radiance distribution;
A2: Control the to-be-measured display screen to display red, blue, and green primary color pictures respectively, and measure the three kinds of primary color pictures respectively by using the spectral measurement module to obtain spectral power distributions (S_{R}(λ)_{i,j}, S_{G}(λ)_{i,j}, and S_{B}(λ)_{i,j}) of the three kinds of primary color pictures in an A region of the to-be-measured display screen;
A3: Obtain peak wavelength positions of the spectral power distributions of the three kinds of primary color pictures according to the spectral power distributions in the A region obtained in step A1, and select three narrow band filters with central wavelengths closest to the three peak wavelength positions;
A4: Control the to-be-measured display screen to display a to-be-measured picture, cut the three narrow band filters selected in step A3 into a light path sequentially, receive light in a B region of the to-be-measured display screen by the planar array detector through the imaging lens and the filters, obtain pixel response values under different bandpass filters by the planar array detector, and then calculate primary color peak intensity coefficients (k_{R}_{_{i,j}}, k_{G}_{_{i,j}}, and k_{B}_{_{i,j}}) at each position in the B region when the to-be-measured display screen displays the to-be-measured picture, where each position in the B region of the to-be-measured display screen corresponds to a specific pixel of the planar array detector;
A5: Superpose the spectral power distributions (S_{B}(λ), S_{G}(λ), and S_{B}(λ)) of primary colors in the A region of the to-be-measured display screen according to the primary color peak intensity coefficients (k_{R}_{_{i,j}}, k_{G}_{_{i,j}} and k_{B}_{_{i,j}}) at each position in the B region of the to-be-measured display screen, and calculate a spectral power distribution S(λ)_{i,j} at each position (i,j) in the B region of the to-be-measured display screen through a formula S(λ)_{i,j}=k_{R}_{_{i,j}}S_{R}(λ)+k_{G}_{_{i,j}}S_{G}(λ)+k_{B}_{_{i,j}}S_{B}(λ), where S_{R}(λ)_{i,j} is a spectral power distribution of the red primary color, S_{G}(λ)_{i,j} is a spectral power distribution of the green primary color, S_{B}(λ)_{i,j} is a spectral power distribution of the blue primary color, and k_{R}_{_{i,j}}, k_{G}_{_{i,j}}, and k_{B}_{_{i,j}} are the primary color peak intensity coefficients, as shown in FIG. 2.
A6: Calculate luminance and chromaticity coordinates of each position in the B region after obtaining the spectral power distribution at each position in the B region.

### Second Method Embodiment

The second method embodiment uses the above described first embodiment apparatus, and bandpass filters 5-1 and filters 5-2 simulating the chromaticity response of human eye are provided in the filter wheel set 5 respectively.

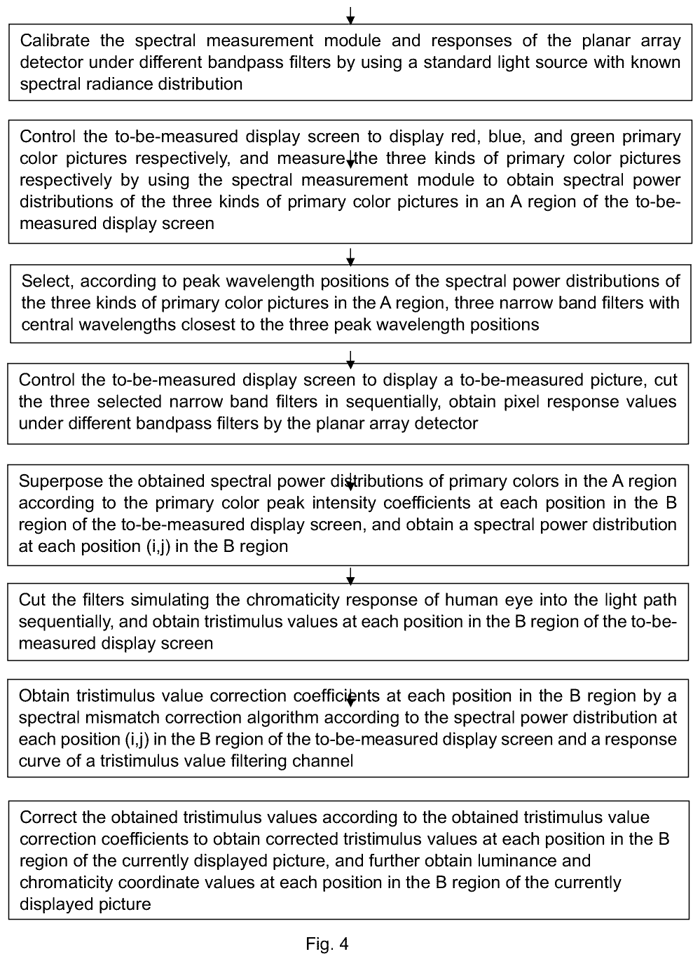

The method embodiment further discloses a display optical field radiation measuring method, as shown in FIG. 4. Measuring steps include:
B1: Calibrate the spectral measurement apparatus and responses of the planar array detector under different bandpass filters by using a standard light source with known spectral radiance distribution;
B2: Control the to-be-measured display screen to display red, blue, and green primary color pictures respectively, and measure the three kinds of primary color pictures respectively by using the spectral measurement apparatus to obtain spectral power distributions (S_{R}(λ)_{i,j}, S_{G}(λ)_{i,j}, and S_{B}(λ)_{i,j}) of the three kinds of primary color pictures in an A region of the to-be-measured display screen;
B3: Select, according to peak wavelength positions of the spectral power distributions of the three kinds of primary color pictures in the A region, three narrow band filters with central wavelengths closest to the three peak wavelength positions;
B4: Control the to-be-measured display screen to display a to-be-measured picture, cut the three narrow band filters selected in step B3 into a light path sequentially, receive light in a B region of the to-be-measured display screen by the planar array detector through the imaging lens and the filters, obtain pixel response values under different bandpass filters by the planar array detector, and then calculate primary color peak intensity coefficients (k_{R}_{_{i,j}}, k_{G}_{_{i,j}}, and k_{B}_{_{i,j}}) at each position in the B region when the to-be-measured display screen displays the to-be-measured picture, where each position in the B region of the to-be-measured display screen corresponds to a specific pixel of the planar array detector;
B5: Superpose the spectral power distributions (S_{R}(λ), S_{G}(λ), and S_{B}(λ)) of primary colors in the A region of the to-be-measured display screen according to the primary color peak intensity coefficients (k_{R}_{_{i,j}}, k_{G}_{_{i,j}}, and k_{B}_{_{i,j}}) at each position in the B region of the to-be-measured display screen, and calculate a spectral power distribution S(λ)_{i,j} at each position (i,j) in the B region of the to-be-measured display screen through a formula S(λ)_{i,j}=k_{R}_{_{i,j}}S_{R}(λ)+k_{G}_{_{i,j}}S_{G}(λ)+k_{R}_{_{i,j}}S_{B}(λ), where S_{R}(λ)_{i,j} is a spectral power distribution of the red primary color, S_{G}(λ)_{i,j} is a spectral power distribution of the green primary color, S_{B}(λ)_{i,j} is a spectral power distribution of the blue primary color, and k_{R}_{_{i,j}}, k_{G}_{_{i,j}}, and k_{B}_{_{i,j}} are the primary color peak intensity coefficients. The primary color peak intensity coefficients in this embodiment refer to absolute value coefficients;
B6: Cut the filters simulating the chromaticity response of human eye into the light path sequentially, and obtain tristimulus values M_{i,j} at each position in the B region under the same picture of the to-be-measured display screen after a beam emitted by the to-be-measured display screen enters the planar array detector through the filters;
B7: Obtain tristimulus value correction coefficients F*(S_{Z}(λ))_{i,j} at each position in the B region by a spectral mismatch correction algorithm according to the spectral power distribution S(λ)_{i,j} at each position (i,j) in the B region of the to-be-measured display screen obtained in step B5 and a response curve of a tristimulus value filtering channel, and calculate

$$a * ( {S}_{Z} ( λ ) ) = \frac{{S}_{A}}{{S}_{Z}} = \frac{{\int }_{{λ}_{min}}^{{λ}_{max}} {S}_{Z} ( λ ) \cdot {s}_{rel} ( λ ) d λ}{\int \text{?} {S}_{Z} ( λ ) \cdot V ( λ ) d λ} / \frac{{\int }_{{λ}_{min}}^{{λ}_{max}} {S}_{A} ( λ ) \cdot {s}_{rel} ( λ ) d λ}{\int \text{?} {S}_{A} ( λ ) \cdot V ( λ ) d λ}$$

$$\text{?} \text{indicates text missing or illegible when filed}$$

according to a formula F*(S_{Z}(λ))_{i,j}=(a*(S_{Z}(λ))_{i,j}⁻¹, where S_{A}(λ) represents a relative spectral power distribution of a standard light source; sᵣₑₗ(λ) represents actual spectral response curves (xᵣₑₗ(λ), yᵣₑₗ (λ) and zᵣₑₗ(λ)) of the planar array detector and the filters simulating the chromaticity response of human eye; S_{Z}(λ) represents a relative spectral power distribution of the to-be-measured display screen, which is obtained in step B5; and V(λ) represents three standard colorimetric observer functions x(λ), y(λ) and z(λ). Three corresponding stimulus correction coefficients F*(S_{Z}(λ)) are obtained accordingly, denoted as k(x)_{i,j}, k(y)_{i,j} and k(z)_{i,j}, respectively.
B8: Correct the tristimulus values M_{i,j} obtained in step B6 according to the tristimulus value correction coefficients F*(S_{Z}(λ)) obtained in step B7 to obtain corrected tristimulus values M′_{i,j} at each position in the B region of the currently displayed picture, and further obtain luminance and chromaticity coordinate values at each position in the B region of the currently displayed picture.

### Third Method Embodiment

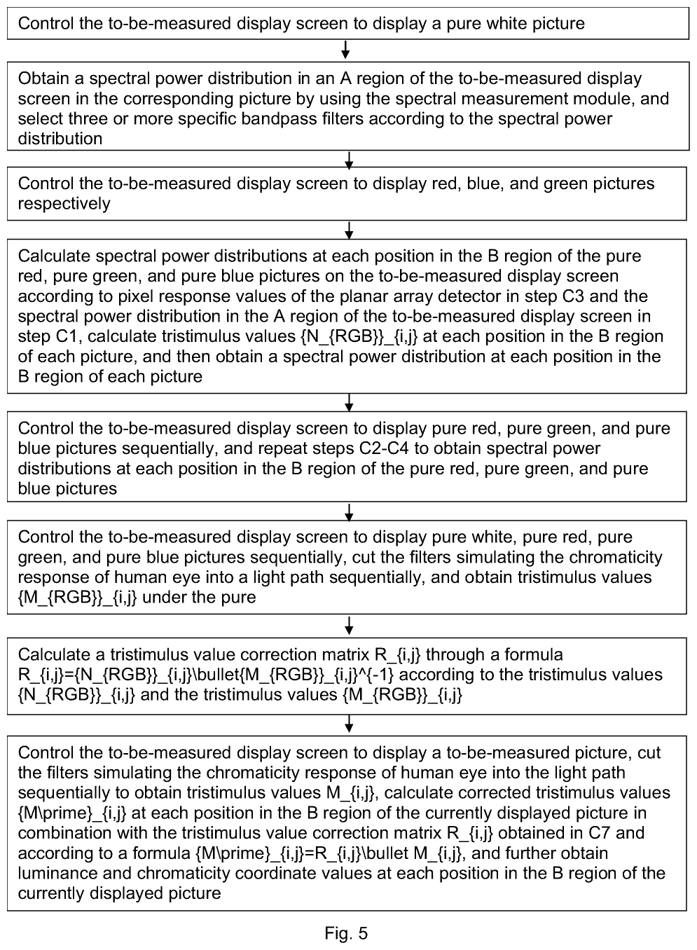

The third method embodiment further discloses another imaging optical radiation measuring method, as shown in FIG. 5. Measuring steps include:
C1: Control the to-be-measured display screen to display a pure white picture;
C2: Obtain a spectral power distribution in an A region of the to-be-measured display screen in the corresponding picture by using the spectral measurement module, and select three or more specific bandpass filters according to the spectral power distribution;
C3: Control the to-be-measured display screen to display a primary color picture, and cut the bandpass filters selected in step C2 into a light path sequentially, where light in a B region of the to-be-measured display screen is incident through the imaging lens and received by the planar array detector through the filters, positions in the B region of the to-be-measured display screen correspond to specific pixels of the planar array detector, and the primary color picture refers to a pure red, pure green, or pure blue picture;
C4: Calculate a spectral power distribution at each position in the B region of a current picture on the to-be-measured display screen according to pixel response values of the planar array detector in step C3 and the spectral power distribution in the A region of the to-be-measured display screen in step C1, and then calculate tristimulus values N_{RGB}_{_{i,j}} of three primary colors in each picture;
C5: Control the to-be-measured display screen to display pure red, pure green, and pure blue pictures sequentially, and repeat steps C2-C4 to obtain spectral power distributions (S_{R}(λ), S_{G}(λ), and S_{B}(λ)) at each position in the B region of the pure red, pure green, and pure blue pictures;
C6: Control the to-be-measured display screen to display pure white, pure red, pure green, and pure blue pictures sequentially, and cut the filters simulating the chromaticity response of human eye into the light path sequentially, where light in the B region of the to-be-measured display screen is incident through the imaging lens and received by the planar array detector through the filters, so as to obtain tristimulus values M_{RGB}_{_{i,j}} under the pure color pictures at each position in the B region;
C7: Calculate a tristimulus value correction matrix R_{i,j} through a formula R_{i,j}=N_{RGB}_{_{i,j}}·M_{RGB}_{_{i,j}}⁻¹ according to tristimulus values N_{RGB}_{_{i,j}} obtained from the spectral power distributions in C5 and the tristimulus values M_{RGB}_{_{i,j}} obtained in C6, where

$${N}_{RGB} = \vert \begin{matrix}{X}_{NR} & {X}_{NG} & {X}_{NB} \\ {Y}_{NR} & {Y}_{NG} & {Y}_{NB} \\ {Z}_{NR} & {Z}_{NG} & {Z}_{NB}\end{matrix} \vert , and {M}_{RGB} = \vert \begin{matrix}{X}_{MR} & {X}_{MG} & {X}_{MB} \\ {Y}_{MR} & {Y}_{MG} & {Y}_{MB} \\ {Z}_{MR} & {Z}_{MG} & {Z}_{MB}\end{matrix} \vert .$$

C8: Control the to-be-measured display screen to display a to-be-measured picture, cut the filters simulating the chromaticity response of human eye into the light path sequentially to obtain tristimulus values M_{i,j}, calculate corrected tristimulus values M′_{i,j} at each position in the B region of the currently displayed picture in combination with the tristimulus value correction matrix R_{i,j} obtained in C7 and according to a formula M′_{i,j}=R_{i,j}·M_{i,j}, and further obtain luminance and chromaticity coordinate values at each position in the B region of the currently displayed picture.

### Fourth Method Embodiment

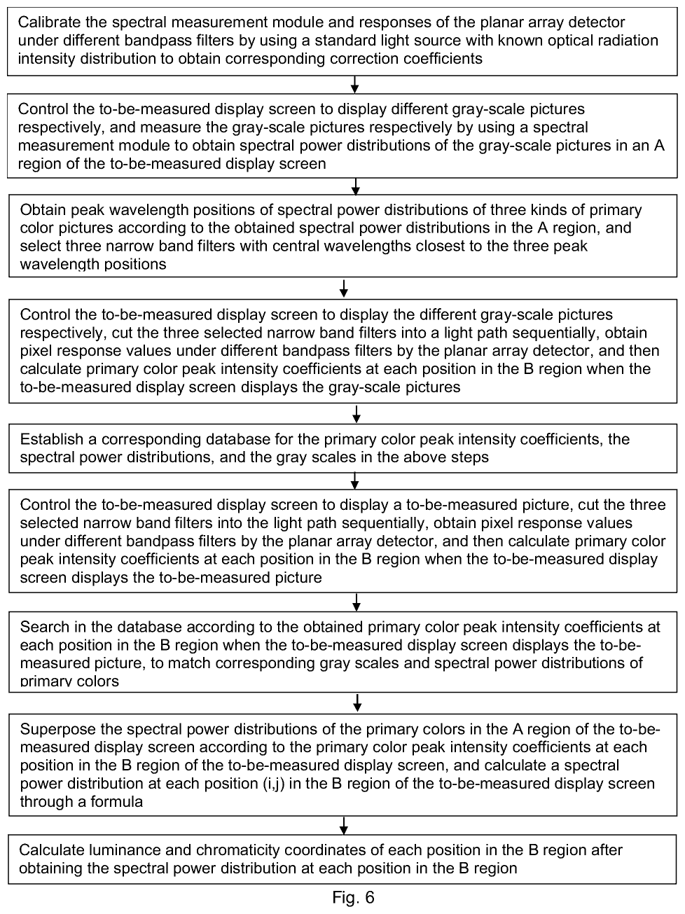

The fourth method embodiment further discloses another imaging optical radiation measuring method, as shown in FIG. 6. Measuring steps include:
D1: Calibrate the spectral measurement apparatus and responses of the planar array detector under different bandpass filters by using a standard light source with known optical radiation intensity distribution to obtain corresponding correction coefficients;
D2: Control the to-be-measured display screen to display different gray-scale pictures respectively, and measure the gray-scale pictures respectively by using a spectral measurement apparatus to obtain spectral power distributions (S_{Rt}(λ), S_{Gt}(λ), and S_{Bt}(λ)) of the gray-scale pictures in an A region of the to-be-measured display screen, where t is 0-255 representing gray scales of the gray-scale pictures;
D3: Obtain peak wavelength positions of spectral power distributions of three kinds of primary color pictures according to the spectral power distributions in the A region obtained in step D2, and select three narrow band filters with central wavelengths closest to the three peak wavelength positions;
D4: Control the to-be-measured display screen to display the different gray-scale pictures in step D2 respectively, cut the three narrow band filters selected in step D3 into a light path sequentially, receive light in a B region of the to-be-measured display screen by the planar array detector through the imaging lens and the filters, obtain pixel response values under different bandpass filters by the planar array detector, and then calculate primary color peak intensity coefficients (k_{Rt}_{_{i,j}}, k_{Bt}_{_{i,j}}, and k_{Gt}_{_{i,j}}) at each position in the B region when the to-be-measured display screen displays the gray-scale t pictures, where each position in the B region of the to-be-measured display screen corresponds to a specific pixel of the planar array detector;
D5: Establish a corresponding database for the primary color peak intensity coefficients (k_{Rt}_{_{i,j}}, k_{Bt}_{_{i,j}}, and k_{Gt}_{_{i,j}}), the spectral power distributions (S_{Rt}(λ), S_{Gt}(λ), and S_{Bt}(λ)), and the gray scales t from step D1 to step D4.
D6: Control the to-be-measured display screen to display a to-be-measured picture, cut the three narrow band filters selected in step D3 into the light path sequentially, receive light in a B region of the to-be-measured display screen by the planar array detector through the imaging lens and the filters, obtain pixel response values under different bandpass filters by the planar array detector, and then calculate primary color peak intensity coefficients (k_{Rt}_{_{i,j}}, k_{Bt}_{_{i,j}}, and k_{Gt}_{_{i,j}}) at each position in the B region when the to-be-measured display screen displays the to-be-measured picture.
D7: Search in the database of step D6 according to the primary color peak intensity coefficients (k_{Rt}_{_{i,j}}, k_{Bt}_{_{i,j}}, and k_{Gt}_{_{i,j}}) obtained in step D6 at each position in the B region when the to-be-measured display screen displays the to-be-measured picture, to match corresponding gray scales and spectral power distributions (S_{Rt}(λ), S_{Gt}(λ), and S_{Bt}(λ)) of primary colors.
D8: Superpose the spectral power distributions (S_{Rt}(λ), S_{Gt}(λ), and S_{Bt}(λ)) of the primary colors in the A region of the to-be-measured display screen according to the primary color peak intensity coefficients (k_{Rt}_{_{i,j}}, k_{Bt}_{_{i,j}}, and k_{Gt}_{_{i,j}}) at each position in the B region of the to-be-measured display screen, and calculate a spectral power distribution Sₜ(λ)_{i,j} at each position (i,j) in the B region of the to-be-measured display screen through a formula Sₜ(6λ)_{i,j}=k_{Rt}_{_{i,j}}S_{Rt}(λ)+k_{Gt}_{_{i,j}}S_{Gt}(λ)+k_{Bt}_{_{i,j}}S_{Bt}(λ), where S_{Rt}(λ) is a spectral power distribution of the red color at the gray scale t, S_{Gt}(λ)_{i,j} is a spectral power distribution of the green color at the gray scale t, S_{Bt}(λ)_{i,j} is a spectral power distribution of the blue color at the gray scale t, and k_{Rt}_{_{i,j}}, k_{Gt}_{_{i,j}}, and k_{Bt}_{_{i,j}} are the primary color peak intensity coefficients at the gray scale t. The primary color peak intensity coefficients in this embodiment refer to absolute value coefficients;
D9: Calculate luminance and chromaticity coordinates of each position in the B region after obtaining the spectral power distribution at each position in the B region.

### First Apparatus Embodiment

The first apparatus embodiment discloses an imaging optical radiation measuring apparatus, as shown in FIG. 7, including a housing 9. An optical lens 1 is disposed on the housing 9. A reflector 2, a first array detector 4, a filter wheel set 5, a spectral measurement module 6, a coaxial driving apparatus 7, and a signal processing and output unit 8 are disposed in the housing 9. The filter wheel set 5 includes two color discs (a first color disc 10 and a second color disc 11), which are disposed on a light path between the optical lens 1 and the first array detector 4 respectively. The color disc has a plurality of hole positions. The filters disposed in the hole positions of the first color disc 10 are several filters simulating the chromaticity response of human eye 5-2, while the filters disposed in the hole positions of the second color disc 11 are several bandpass filters 5-1. The first array detector 4 is a planar array detector. The coaxial driving apparatus 7 is a timing motor capable of switching and combining the two color discs in time series. The timing motor is electrically connected to the two color discs in time series to cut the filters on the corresponding color discs into a measuring light path respectively. The reflector 2 is disposed at a hole position of the first color disc 10 and can be cut into or out of the light path behind the optical lens 1 with the rotation of the first color disc 10. When the reflector 2 is cut into the light path, a second measuring light path is formed from the optical lens 1 through the reflector 2 to the spectral measurement module 6. When the reflector 2 is cut out of the light path, a first measuring light path is formed from the optical lens 1 through the filters to the first array detector 4. The signal processing and output unit 8 is electrically connected to the first array detector 4 and the spectral measurement module 6, respectively. As shown in FIG. 8, the spectral measurement module 6 includes an incident slit 6-1, a dispersion element 6-2, and a second array detector 6-3. When the reflector 2 is cut into the light path, a beam emitted by a to-be-measured display screen is incident from the optical lens 1 through the reflector 2 to the incident slit 6-1 and then split by the dispersion element 6-2, and split beams are projected onto the second array detector 6-2 to measure spectral power distribution at a specific point. The reflector 2 is cut out of the measuring light path, and the beam emitted by the to-be-measured display screen is incident from the optical lens 1, passes through the filters on the corresponding hole positions of the first color disc 10 and the second color disc 11, and is received by the first array detector 4, so as to obtain a luminance value or tristimulus value of a to-be-measured region of the to-be-measured display screen. The signal processing and output unit 8 processes and calculates signals received by the spectral measurement module 6 and the first array detector 4, so as to obtain information such as planar array luminance and chromaticity of the to-be-measured display screen, and to quickly and accurately measure the luminance, chromaticity, and uniformity of the to-be-measured display screen.

Preferably, a measurement point of the spectral measurement module 6 is located at a designated position within a measurement region of the first array detector 4, so as to measure a spectral power distribution at the designated position.

### Second Apparatus Embodiment

The second apparatus embodiment discloses an imaging optical radiation measuring apparatus, as shown in FIG. 9, including a housing 9. An optical lens 1 is disposed on the housing 9. A light splitter 3, a first array detector 4, a filter wheel set 5, a spectral measurement module 6, a coaxial driving apparatus 7, and a signal processing and output unit 8 are disposed in the housing 9. The filter wheel set 5 includes two color discs (a first color disc 10 and a second color disc 11), which are disposed on a light path between the optical lens 1 and the first array detector 4 respectively. The color disc has a plurality of hole positions, and three or more filters 5-1 simulating the tristimulus value response of human eye are disposed in the hole positions. The filters disposed in the hole positions of the first color disc 10 are several filters simulating the chromaticity response of human eye, while the filters disposed in the hole positions of the second color disc 11 are several bandpass filters. The light splitter 3 is disposed on a light path between the optical lens 1 and the filter wheel set 5. A beam emitted by a to-be-measured display screen is incident from the optical lens 1 to the light splitter 3 and split into two outgoing light paths by the light splitter 3. One path of outgoing beam is incident onto the first array detector 4 through the filters 5-1 on the filter wheel set 5 to form a first measuring light path, so as to obtain a luminance value or tristimulus value of a to-be-measured region of the to-be-measured display screen. The other path of outgoing beam is incident onto the spectral measurement module 6 to form a second measuring light path, so as to obtain spectral power distribution at a specific point on the to-be-measured display screen. The coaxial driving apparatus 7 is a timing motor capable of switching and combining two or more color discs in time series. The timing motor is electrically connected to the two or more color discs in time series to cut the filters on the corresponding color discs into a measuring light path respectively. The light splitter 3 is a semi-transparent and semi-reflective mirror. The signal processing and output unit 8 is electrically connected to the first array detector 4 and the spectral measurement module 6 respectively, processes and calculates signals received by the spectral measurement module 6 and the first array detector 4, and corrects measurement results of the imaging measuring apparatus by using measurement results of the spectral measurement module, so as to quickly and accurately measure the luminance, chromaticity, and uniformity of the display screen.

### Third Apparatus Embodiment

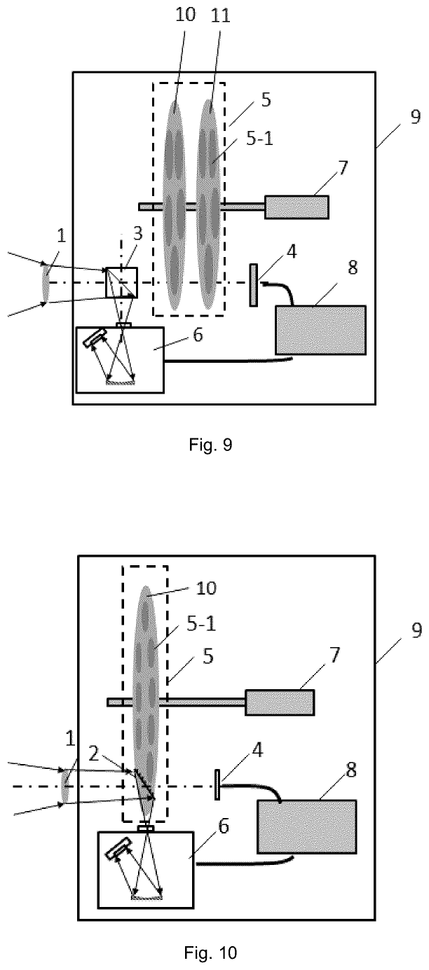

The third apparatus embodiment discloses an imaging optical radiation measuring apparatus, as shown in FIG. 10, including a housing 9. An optical lens 1 is disposed on the housing 9. A reflector 2, a first array detector 4, a filter wheel set 5, a spectral measurement module 6, a coaxial driving apparatus 7, and a signal processing and output unit 8 are disposed in the housing 9. The filter wheel set 5 includes a color disc (first color disc 10) disposed on a light path between the optical lens 1 and the first array detector 4. The first color disc has a plurality of hole positions, and three or more filters 5-1 are disposed in the hole positions, where the filters are several bandpass filters. The first array detector 4 is a planar array detector. The coaxial driving apparatus 7 can switch the color disc in time series to cut the filters on the corresponding color disc into a measuring light path respectively. The reflector 2 is disposed at a hole position of the first color disc 10 and can be cut into or out of the light path behind the optical lens 1 with the rotation of the first color disc 10. When the reflector 2 is cut into the light path, a second measuring light path is formed from the optical lens 1 through the reflector 2 to the spectral measurement module 6. When the reflector 2 is cut out of the light path, a first measuring light path is formed from the optical lens 1 through the filters to the first array detector 4. The signal processing and output unit 8 is electrically connected to the first array detector 4 and the spectral measurement module 6, respectively. As shown in FIG. 8, the spectral measurement module 6 includes an incident slit 6-1, a dispersion element 6-2, and a second array detector 6-3. When the reflector 2 is cut into the light path, a beam emitted by a to-be-measured display screen is incident from the optical lens 1 through the reflector 2 to the incident slit 6-1 and then split by the dispersion element 6-2, and split beams are projected onto the second array detector 6-2 to measure spectral power distribution at a specific point. The reflector 2 is cut out of the measuring light path, and the beam emitted by the to-be-measured display screen is incident from the optical lens 1, passes through the filters simulating the chromaticity response of human eye on the corresponding hole positions of the first color disc 10, and is received by the first array detector 4, so as to obtain a luminance value or tristimulus value of a to-be-measured region of the to-be-measured display screen. The signal processing and output unit 8 processes and calculates signals received by the spectral measurement module 6 and the first array detector 4, so as to obtain information such as planar array luminance and chromaticity of the to-be-measured display screen, and to quickly and accurately measure the luminance, chromaticity, and uniformity of the to-be-measured display screen.

Specific implementations of the present invention are explained above with reference to the accompanying drawings, but those skilled in the art should understand that the above embodiments are only for illustration and not to limit the scope of the present invention. Those skilled in the art should understand that the above embodiments can be modified without departing from the scope and spirit of the present invention. The scope of protection of the present invention is limited by the appended claims.

What is claimed is:

1. A display optical field radiation measuring method, wherein hyperspectral information of a to-be-measured display screen is measured by a spectral measurement module, filters, and an imaging measuring apparatus comprising a planar array detector, and the method comprises the following steps:
S1: controlling the to-be-measured display screen to display a first group of pictures, and obtaining spectral power distributions in an A region of the to-be-measured display screen in the corresponding pictures by using the spectral measurement module;
S2: selecting two or more specific bandpass filters according to the spectral power distributions in the A region obtained in step S1;
S3: controlling the to-be-measured display screen to display a second group of pictures, and cutting the filters selected in step S2 into a light path sequentially, wherein light in a B region of the to-be-measured display screen is received by the planar array detector through an imaging lens and the filters, and positions in the B region of the to-be-measured display screen are imaged on corresponding pixels of the planar array detector; and
S4: calculating, according to pixel response values of the planar array detector in step S3 and the spectral power distributions in the A region of the to-be-measured display screen in step S1, the spectral power distribution at each position in the B region when the to-be-measured display screen displays the second group of pictures.

2. The display optical field radiation measuring method according to claim 1, wherein primary color peak wavelengths of the to-be-measured display screen are obtained according to the spectral power distributions in the A region in step 2, and the transmission band of the selected bandpass filters cover the primary color peak wavelengths of the to-be-measured display screen.

3. The display optical field radiation measuring method according to claim 2, wherein each primary color of the to-be-measured display screen corresponds to at least one bandpass filter, and the quantity of the bandpass filters is greater than or equal to that of primary colors of the to-be-measured display screen.

4. The display optical field radiation measuring method according to claim 1 or 2, wherein in step S1, the first group of pictures comprises two or more different pictures, and the spectral measurement module measures a spectral power distribution in each picture respectively.

5. The display optical field radiation measuring method according to claim 1, wherein step S4 specifically comprises: analyzing spectral power distributions (S_{R}(λ), S_{G}(λ), and S_{B}(λ)) of primary colors of the to-be-measured display screen according to the spectral power distributions in the A region of the to-be-measured display screen measured in step S1; calculating, according to the pixel response values of the planar array detector in step S3, primary color peak intensity coefficients (k_{R}_{_{i,j}}, k_{G}_{_{i,j}}, and k_{B}_{_{i,j}}) at each position (i,j) when the to-be-measured display screen displays the second group of pictures; and combining the spectral power distributions of the primary colors and peak intensity coefficients to obtain the spectral power distribution S(λ)_{i,j} at each position.

6. The display optical field radiation measuring method according to claim 5, wherein the A region of the to-be-measured display screen is located within the B region, and a pixel or a set of more pixels specific on the planar array detector corresponds to the A region.

7. The display optical field radiation measuring method according to claim 6, wherein the first group of pictures in step S1 and the second group of pictures in step S3 have one or more identical pictures, response values obtained by the planar array detector in the A region under different bandpass filters in the same picture are compared with peak intensities of the spectral power distributions in the A region obtained in step S1 to obtain the primary color peak intensity coefficient responsivities under the combination of the planar array detector and the bandpass filters, and then primary color peak intensity coefficients at each position in the corresponding picture are obtained in proportion when any picture on the to-be-measured display screen is measured.

8. The display optical field radiation measuring method according to claim 5 or 6 or 7, wherein the first group of pictures in step S1 comprises two or more pictures in different gray scales; primary color spectral power distributions of the to-be-measured display screen in different gray scales of the first group of pictures are analyzed in step S4, so as to determine a gray scale of each position while the primary color peak intensity coefficients at each position when the to-be-measured display screen displays the second group of pictures are calculated; and the primary color spectral power distribution in the corresponding gray scale is combined with the primary color peak intensity coefficient to obtain the spectral power distribution at each position.

9. The display optical field radiation measuring method according to claim 1 or 2, wherein after step S4, the following steps are further comprised:
S5: cutting filters simulating the luminance or chromaticity response of human eye into the light path, controlling the to-be-measured display screen to display a third group of to-be-measured pictures, and obtaining, by the planar array detector, luminance values or tristimulus values at each position in the B region of the to-be-measured display screen;
S6: obtaining luminance or tristimulus value correction coefficients for each position in the B region by using a correction algorithm according to the spectral power distribution obtained in step S4; and
S7: correcting the luminance values or tristimulus values obtained in step S5 by using the correction coefficients obtained in step S6 to obtain corrected luminance values or tristimulus values at each position in the B region in the third group of pictures.

10. The display optical field radiation measuring method according to claim 9, wherein the third group of pictures in step S5 is the same as the second group of pictures, and the correction algorithm described in step S6 comprises, but is not limited to, a spectral mismatch correction algorithm and a ratio method.

11. The display optical field radiation measuring method according to claim 9, wherein the second group of pictures in step S3 is primary colors respectively and a mixture of primary colors, all in the same gray scale; and the spectral power distribution at each position in these pictures is obtained in step S4; in step S5, the filters simulating the chromaticity response of human eye are sequentially cut in; the correction algorithm used in step S6 is a matrix correction algorithm, and the tristimulus value correction coefficients at all positions are of a correction coefficient matrix; and the third group of pictures in steps S5 and S7 are any display pictures.

12. An imaging optical radiation measuring apparatus, comprising a housing, wherein an optical lens is disposed on the housing; a first array detector, a spectral measurement module, a filter wheel set, a light path switching apparatus, and a signal processing and output unit are disposed in the housing; the filter wheel set has a plurality of hole positions, and two or more filters are disposed in the hole positions; a measured beam enters the housing through an optical lens, and the light path switching apparatus switches the measured beam to two or more measuring light paths simultaneously or sequentially, wherein a first measuring light path is from the optical lens to the first array detector, and a second measuring light path is from the optical lens to the spectral measurement module; the filter wheel set is disposed between the optical lens and the first array detector; and the signal processing and output unit is electrically connected to the first array detector and the spectral measurement module respectively.

13. The imaging optical radiation measuring apparatus according to claim 12, wherein the light path switching apparatus is a light splitter, the measured beam coming from the optical lens and incident to the light splitter is split into two or more paths of outgoing beams, one path of outgoing beam is incident to the first array detector to form the first measuring light path, and the other path of outgoing beam is incident to the spectral measurement module to form the second measuring light path.

14. The imaging optical radiation measuring apparatus according to claim 12, wherein the light path switching apparatus is a reflector that can be cut into or out of a measuring light path; when the reflector is cut into the light path, the second measuring light path becomes effective; and when the reflector is cut out of the light path, the first measuring light path becomes effective.

15. The imaging optical radiation measuring apparatus according to claim 13, wherein the light splitter is disposed on a light path between the optical lens and the filter wheel set, the first measuring light path starts from the optical lens to the light splitter, then passes through the hole positions on the filter wheel set and finally reaches the first array detector, and the second measuring light path is from the optical lens to the light splitter and then reaches the spectral measurement module.

16. The imaging optical radiation measuring apparatus according to claim 12 or 13 or 14, wherein the light path switching apparatus is disposed on a hole position of the filter wheel set, and can be cut into or out of the light path behind the optical lens with the rotation of the filter wheel set; and the second measuring light path from the optical lens through the light path switching apparatus to the spectral measurement module is formed only when the light path switching apparatus is cut into the light path.

17. The imaging optical radiation measuring apparatus according to claim 12 or 13 or 14, wherein receiving surfaces of the first array detector and the spectral measurement module are located on an imaging surface of the optical lens.

18. The imaging optical radiation measuring apparatus according to claim 12 or 13 or 14, further comprising a field diaphragm, wherein the field diaphragm is disposed in the second measuring light path in front of the spectral measurement module.

19. The imaging optical radiation measuring apparatus according to claim 12 or 13 or 14, wherein the filter wheel set is provided with three or more filters simulating the tristimulus value response of human eye, or the filter wheel set is provided with three or more bandpass filters, or the filter wheel set is provided with neutral filters with different transmittance, or the filter wheel set is provided with filter of the combined types of the above.

20. The imaging optical radiation measuring apparatus according to claim 12, further comprising a coaxial driving apparatus, wherein the coaxial driving apparatus drives the filter wheel set to cut specific filters into a measuring light path sequentially.

21. The imaging optical radiation measuring apparatus according to claim 20, wherein the filter wheel set comprises two or more color discs; and the coaxial driving apparatus is a timing motor capable of switching and combining two or more color discs in time series, and the timing motor is electrically connected to the two or more color discs in time series to cut the filters on the corresponding color discs into the measuring light path respectively.

22. The imaging optical radiation measuring apparatus according to claim 12, wherein a measurement point of the spectral measurement module is located at a designated position within a measurement region of the first array detector, so as to measure a spectral power distribution at the designated position.
